(19) United States
(12) Patent Application Publication
(10) Pub. No.: US 2009/0034164 A1
(43) Pub. Date: Feb. 5, 2009

(54) Anchor structure for electronic card connector pins

(75) Inventors: Kuo-Chi Lee, Taipei County (TW); Shih-Chia Lai, Taipei County (TW)

Correspondence Address: Joe McKinney Muncy, PO Box 1364, Fairfax, VA, 22038-1364, US

(73) Assignee: DRAGONSTATE TECHNOLOGY CO., LTD.

(21) Appl. No.: 11/882,543

(22) Filed: Aug. 2, 2007

(51) Int. Cl. H02B 1/00

(52) U.S. Cl. 361/600

(57) ABSTRACT

An anchor structure for electronic card connector pins to facilitate anchoring and insertion of a plurality of pins includes an anchor member held on a receptacle and extended from a coupling port thereof. The anchor member has a plurality of holding spaces each holds a pin. Each holding space has an insertion track to facilitate anchoring and insertion of the pin in the holding space.

### FIELD OF THE INVENTION

The present invention relates to an anchor structure and particularly to an anchor structure for electronic card connector pins.

### BACKGROUND OF THE INVENTION

Electronic card connectors are widely used on different electronic devices these days. The electronic card connectors have many different types corresponding to different specifications of electronic cards to establish electric connection between the electronic cards and the electronic devices through a pin structure located in the connectors. Refer to FIG. 1 for a conventional electronic card connector. It mainly has a receptacle 1 and a plurality of pins 2 to establish electric connection between an electronic card and an electronic device.

In the event that the length of the pins 2 exceeds a certain range, the two ends of the pins 2 are spaced from each other at a greater distance. Hence during the process of inserting the pins 2 into the receptacle 1, skew, bending, deformation or fracturing of the pins 2 is prone to occur. In some cases the pins 2 and the receptacle 1 are integrally formed through an injection forming process. As the pins 2 are spaced from one another densely, a greater precision is required, otherwise production yield decreases. Moreover, the pins 2 have a bare middle portion. This easily causes short circuit when energized with electricity. These issues related to the electronic card connector pins remain to be overcome in the industry.

### SUMMARY OF THE INVENTION

The primary object of the present invention is to provide an anchor structure for electronic card connector pins to avoid the pins from skewing, deforming or fracturing during insertion process of the pins into electronic card connectors.

To achieve the foregoing object the anchor structure of the invention aims to anchor a plurality of pins to facilitate insertion. It has an anchor member held on a receptacle and extended from a coupling port of the receptacle. The anchor member has a plurality of holding spaces and each holding space holds one pin. Each of the holding spaces has an insertion track to confine and guide the pin to facilitate insertion.

Another object of the invention is to prevent short circuit from occurring in the middle portion of the pins. To achieve this object the anchor member contains insulation material.

Yet another object of the invention is to enhance the sturdiness of the pin structure. To achieve this object the middle portion of the pins and the surrounding wall of the holding spaces are in contact with each other.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional electronic card connector.

FIG. 2 is an exploded view of an embodiment of the invention.

FIG. 3 is a perspective view of an embodiment of the invention.

FIG. 4 is a cross section of an embodiment of the invention.

FIG. 5 is a cross section of another embodiment of the invention.

FIG. 6 is a cross section of yet another embodiment of the invention.

FIG. 7 is an exploded view of still another embodiment of the invention.

FIG. 8 is a schematic view of still another embodiment of the invention showing a spacer and a receptacle in a coupling condition.

FIG. 9 is a cross section of still another embodiment of the invention.

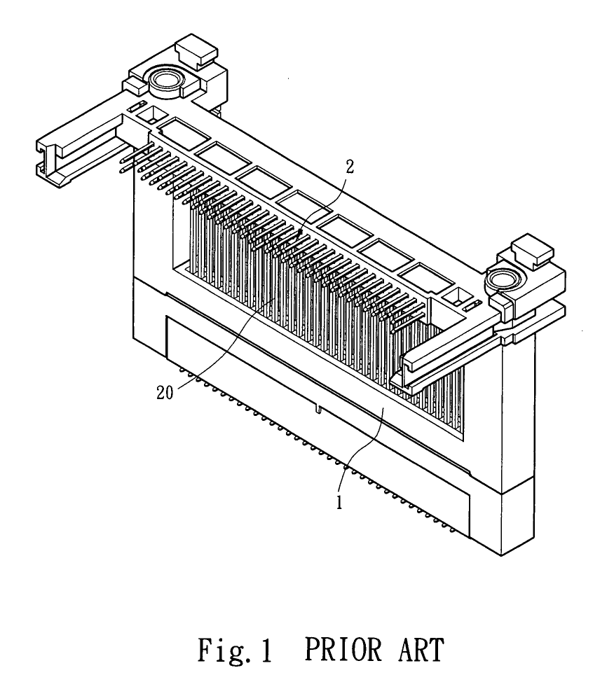

### DETAILED DESCRIPTION OF THE PREFERRED EMBODIMENTS

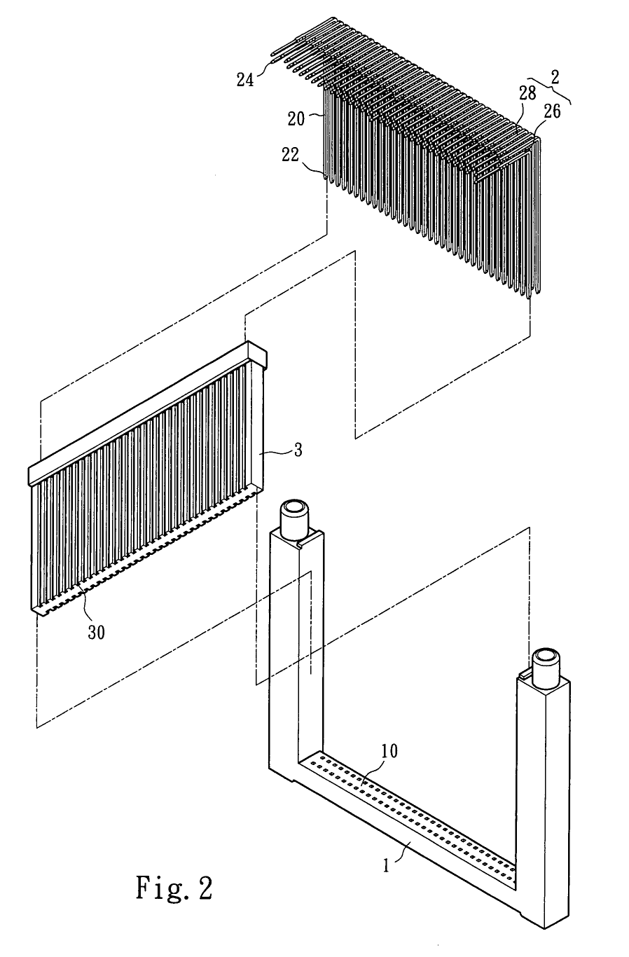

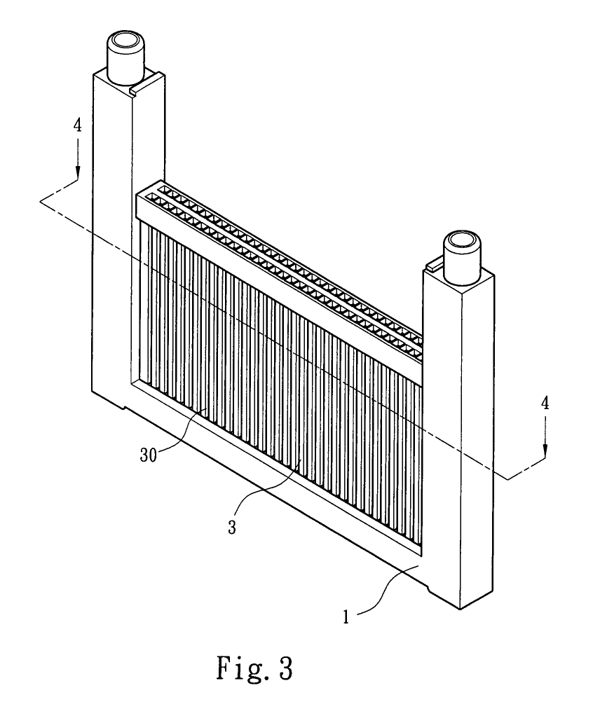

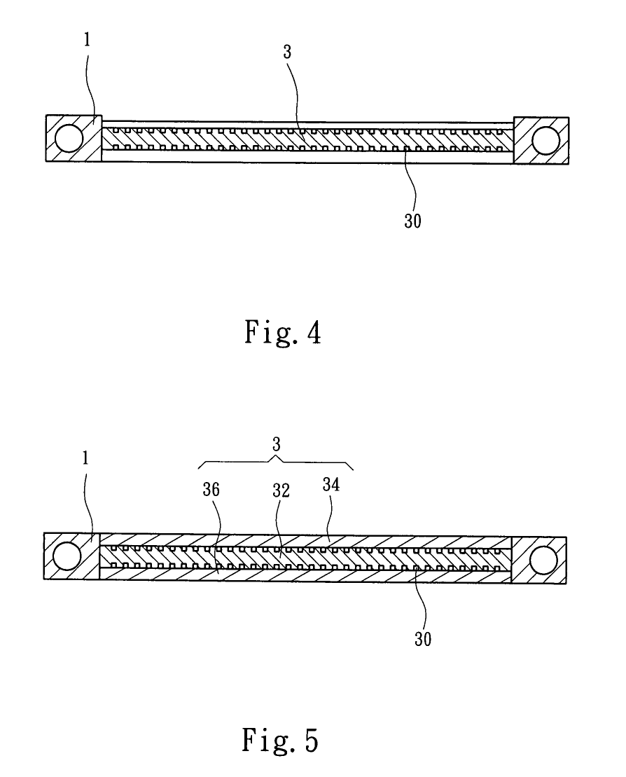

Please refer to FIGS. 2, 3 and 4 for an embodiment of the invention. The invention provides an anchor stricture for electronic card connector pins to facilitate insertion of a plurality of pins 2. Each of the pins 2 has a first end 22 connecting to an internal circuit of an electronic card connector and a second end 24 to be coupled with an electronic card. The first end 22 and the second end 24 are bridged by a middle portion 20. In this embodiment the pins 2 have a first pin row 26 and a second pin row 28. Each pin 2 also has a bend portion.

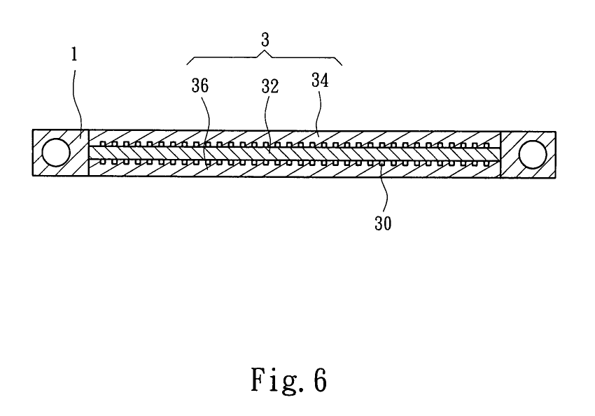

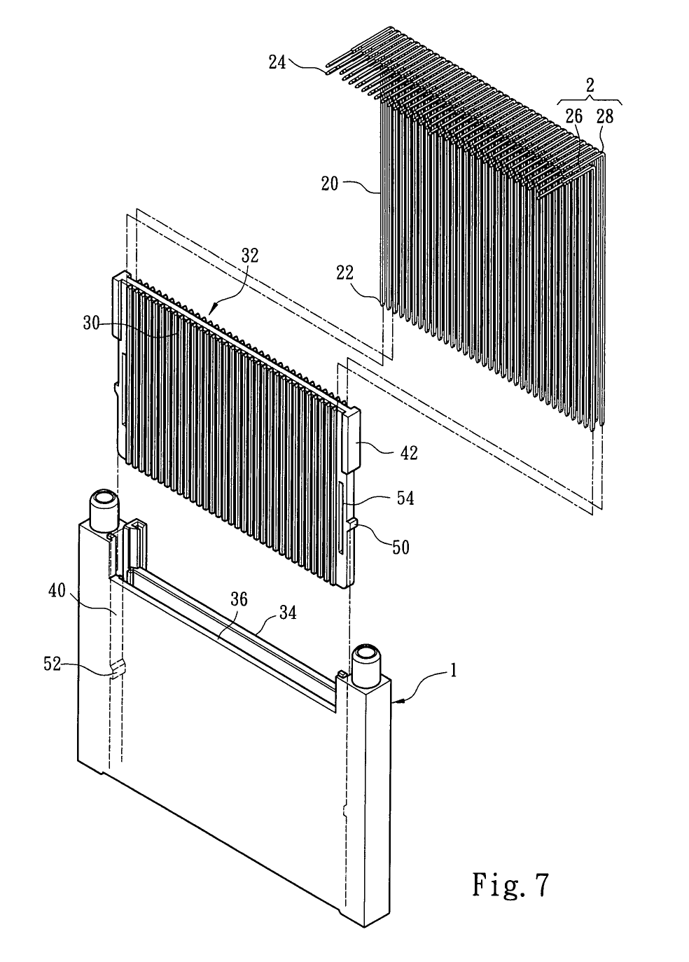

The invention further has an anchor member 3 held on a receptacle 1 and extended from a coupling port 10 formed on the receptacle 1. The anchor member 3 has a plurality of holding spaces (such as holding troughs or openings). Each of the holding spaces holds one of the pins 2. Each holding space also has an insertion track (not shown in the drawings) to anchor and hold the pin 2 in the holding space to facilitate insertion of the pin 2 into the receptacle 1. In this embodiment the anchor member 3 mates the pin 2 and is extended from the coupling port 10 along the pin 2 to the bend portion of the pin 2. The anchor member 3 has an insulation material inside to prevent short circuit in the middle portion 20 of the pin 2. Moreover, the holding space has a holding trough 30 which has a surrounding wall in contact with the middle portion 20 of the pin 2 to enhance the sturdiness of the pin 2. In addition, the insertion track is formed in the axial direction of the holding trough 30. FIG. 5 illustrates another embodiment in which the anchor member 3 is a spacer interposed between the first pin row 26 and the second pin row 28. FIG. 6 depicts yet another embodiment in which the anchor member 3 includes a spacer 32 interposed between the first pin row 26 and the second pin row 28, and a first clipping plate 34 and a second clipping plate 36 clipping the first pin row 26, the spacer 32 and the second pin row 28. And the holding trough 30 is formed on the spacer 32. FIG. 7 shows still another embodiment in which the anchor member 3 includes a spacer 32 interposed between the first pin row 26 and the second pin row 28, and a first clipping plate 34 and a second clipping plate 36 clipping the first pin row 26, the spacer 32 and the second pin row 28. And the holding trough 30 is formed on the first and second clipping plates 34 and 36.

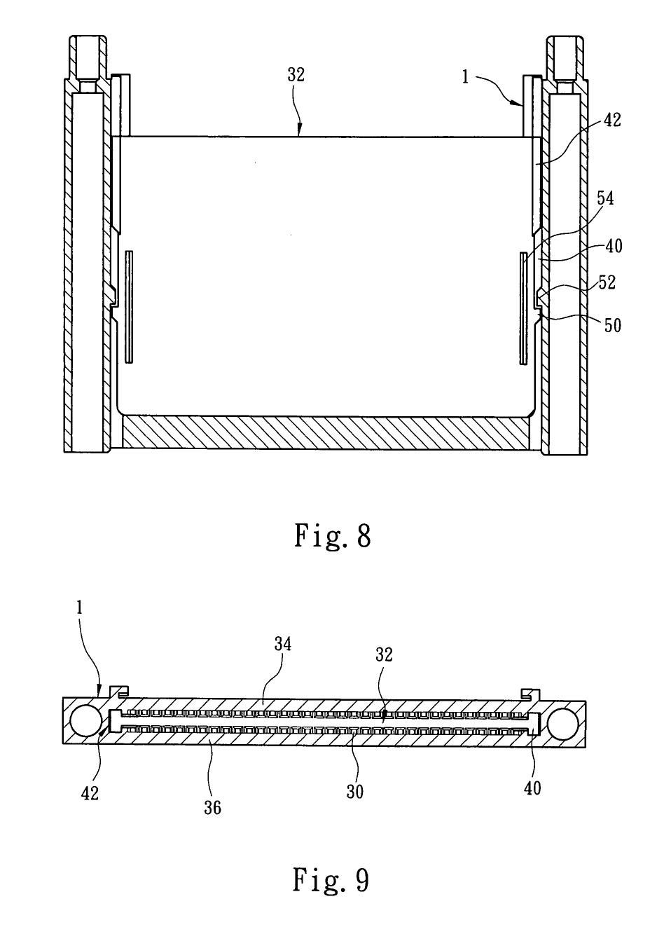

Refer to FIGS. 7, 8 and 9 for the still another embodiment of the invention. In this embodiment the first and second clipping plates 34 and 36 are integrally formed with the receptacle 1 (referring to FIG. 9). Therefore they can be made through an injection forming process to save molding cost. There are a guiding track 40 and a guiding member 42 located between the spacer 32 and the receptacle 1 to facilitate anchoring and assembly of the anchor member 3 and the receptacle 1. The anchor member 3 and the receptacle 1 also have respectively a latch member 50 and 52 mating each other to prevent the anchor member 3 and the receptacle 1 from skewing or separating after assembled. The latch member 50 has an extensible space 54 at one side to provide elastic coupling for the latch members 50 and 52.

As a conclusion the anchor member 3 of the invention provides anchor function for the pins 2 during insertion into the receptacle 1. Hence skewing, deformation or fracturing of the pins 2 that might otherwise happen during the insertion process can be prevented. Moreover, the anchor member 3 provides insulation and can prevent short circuit from taking place in the middle portion 20 of the pins 2. As the middle portion 20 of the pins 2 is in contact with the surrounding wall of the holding space, the sturdiness of the pins 2 can also be enhanced. Thus the invention provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An anchor structure for electronic card connector pins, comprising:
an anchor member which is located on a receptacle and extended from a coupling port of the receptacle and has a plurality of holding spaces each having an insertion track to allow a pin to be confined and inserted in each of the holding spaces.

2. The anchor structure of claim 1, wherein the anchor member contains insulation material.

3. The anchor structure of claim 1, wherein the holding space is a holding trough.

4. The anchor structure of claim 3, wherein the insertion track is formed axially along the axis of the holding trough.

5. The anchor structure of claim 1, wherein the pin has a first end row and a second end row.

6. The anchor structure of claim 5, wherein the anchor member has a spacer interposed between the first end row and the second end row.

7. The anchor structure of claim 6, wherein the anchor member has a first clipping plate and a second clipping plate that clip the first end row, the spacer and the second end row.

8. The anchor structure of claim 6, wherein the holding spaces are formed on the first clipping plate and the second clipping plate.

9. The anchor structure of claim 8, wherein the holding spaces are formed on the spacer.

10. The anchor structure of claim 8, wherein the first clipping plate and the second clipping plate are integrally formed with the receptacle.

11. The anchor structure of claim 1, wherein the pin has a first end connecting to an internal circuit of an electronic card connector and a second end to be coupled with an electronic card.

12. The anchor structure of claim 11, wherein a middle portion is between the first end and the second end and the middle portion being in contact with a surrounding wall of the holding space to form a sturdy pin structure.

13. The anchor structure of claim 11, wherein the pin has a bend portion.′

14. The anchor structure of claim 13, wherein the anchor member is extended from the first end of the pin to the bend portion.

15. The anchor structure of claim 1, wherein the anchor member and the receptacle have respectively a guiding track and a guiding member mating each other.

16. The anchor structure of claim 1, wherein the anchor member and the receptacle have respectively a latch member mating each other.

17. The anchor structure of claim 16, wherein the latch members have an extensible space at one side to allow the latch members to be coupled elastically.
